(19) United States
(12) Patent Application Publication
(10) Pub. No.: US 2026/0234016 A1
(43) Pub. Date: Aug. 13, 2026

(54) PROCESS FOR MANUFACTURING OXIDES

(71) Applicant: Evonik Operations GmbH, Essen (DE)

(72) Inventors: Franz Schmidt, Gross-Gerau (DE); Alexander Lygin, Griesheim (DE)

(73) Assignee: Evonik Operations GmbH, Essen (DE)

(21) Appl. No.: 19/153,820

(22) PCT Filed: Jan. 31, 2024
(86) PCT No.: PCT/EP2024/052306

§ 371 Date: Aug. 5, 2025

(30) Foreign Application Priority Data
Feb. 10, 2023 (EP) 23156050.9

(51) Int. Cl. C01F 7/30; C01B 33/12; C01G 23/047; C25B 1/04

(52) U.S. Cl. CPC C01F 7/30; C01B 33/126; C01G 23/047; C25B 1/04

(57) ABSTRACT

The present invention relates to a pyrogenic process for manufacturing metal oxides or metalloid oxides wherein a metal precursor and/or a metalloid precursor is introduced into a flame formed by burning a gas mixture comprising oxygen and hydrogen, wherein at least a part of the hydrogen has been obtained from electrolysis of water or an aqueous solution, using electrical energy, at least a part of which has been obtained from a renewable energy source, and wherein at least a part of the thermal energy of the flame is transferred to a first heat transmission medium by means of at least one exchanger, thereby heating the first heat transmission medium to a maximal temperature in the range between 8° and 150° C.

Finely dispersed metal oxide and metalloid oxide powders, such as silica, alumina, titania and others are required for a broad range of technical applications today. Well-established routes for their production are based on pyrogenic processes, i.e. processes involving flame hydrolysis and/or flame pyrolysis of precursors (cf. Ullmann's Encyclopedia of Industrial Chemistry (1982) Volume 21, page 464). The flame used in these processes is typically formed by combining and igniting streams of a gas mixture comprising hydrogen and a gas mixture comprising oxygen in a burner. Volatile metal or metalloid precursors are supplied into the hydrogen or oxygen stream or into the flame directly and converted therein to finely dispersed metal oxide and/or metalloid oxide powders.

The present invention relates to a pyrogenic process for manufacturing metal oxides or metalloid oxides wherein a metal precursor and/or a metalloid precursor is introduced into a flame formed by burning a gas mixture comprising oxygen and hydrogen, wherein at least a part of the hydrogen has been obtained from electrolysis of water or an aqueous solution, using electrical energy, at least a part of which has been obtained from a renewable energy source, and wherein at least a part of the thermal energy of the flame is transferred to a first heat transmission medium, thereby heating the first heat transmission medium to a temperature in the range between 8° and 150° C.

Hydrogen supply for pyrogenic processes today is typically obtained by steam reforming of fossil methane inventories, thus releasing fossil carbon into the atmosphere:

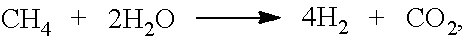

Moreover, steam reforming requires significant input of thermal energy for obtaining the elevated process temperatures required therefor. Generating thermal energy in a typical present day industry setting, however, releases additional fossil carbon into the atmosphere.

Accordingly, manufacturing finely dispersed metal oxide and metalloid oxide powders by present day pyrogenic processes contributes to the atmospheric release of fossil carbon. Given the large scale of current global pyrogenic process operations, their contribution to carbon dioxide emissions is undoubtedly significant. Considering the increasing urgency for alleviating global warming, caused by the atmospheric release of CO₂, reducing such emissions in all chemical processes including pyrogenic manufacturing of metal and metalloid oxides is becoming a top priority. Based on this it is imperative that evaluation of any alternative to current pyrogenic processes needs to include consideration of CO₂ emissions of the overall process instead of merely focusing on improvements accessible at individual substeps.

One of the problems to be solved by the current invention, accordingly, is providing pyrogenic processes for manufacturing finely dispersed metal oxide and metalloid oxide powders, such as silica, alumina, titania and others with lower CO₂-emissions.

Collecting and using thermal energy downstream of the burner site might appear at first glance as a rewarding means for reducing energy consumption of pyrogenic processes, however, technical requirements present severe obstacles to the generation of overheated steam with temperatures above 200° C. and pressures above 5 bar, typically required for conversion of thermal energy into electric energy. WO2008000302A1 discloses, that cooling the walls of a flame hydrolysis reactor to temperatures below 500° C., e.g. 170° C., is beneficial. In other cases, cooling down reactor walls to even lower temperatures, e.g. below 120° C. is suggested, so that the corresponding heat exchanger, usually filled with circulating water, may be operated at low pressure and the material of the reactor walls (e.g. aluminum) is protected from the destructive effects of high temperatures and pressures. Harvesting thermal energy from pyrogenic processes performed in accord with these specifications, thus, becomes very difficult.

U.S. Pat. No. 6,248,495 discloses a process for manufacturing metal oxide by introducing a metal precursor into a flame, wherein the flame used is formed by burning a gas mixture comprising oxygen and hydrogen.

US 2009/280048 discloses a metal oxide production process wherein a burner is used and wherein the reactor wall is cooled to a temperature of less than 500° C.

Thus, another problem to be solved by the present invention is providing pyrogenic processes for manufacturing finely dispersed metal oxide and metalloid oxide powders, such as silica, alumina, titania and others with reduced overall CO₂-emissions and minimal external fossil-based energy consumption, while maximally re-using energy generated in the process operated with reactor wall temperatures below 120° C.

### THE PRESENT INVENTION

The problems discussed above are solved by the present invention with a process for manufacturing metal oxides or metalloid oxides, comprising the following steps:
(a) introducing a metal precursor and/or a metalloid precursor into a flame,
   wherein the flame used in step (a) is formed by burning a gas mixture comprising oxygen and hydrogen,
   wherein at least a part of the hydrogen has been obtained from electrolysis of water or an aqueous solution, using electrical energy, at least a part of which has been obtained from a renewable energy source,
(b) transferring at least a part of the thermal energy of the flame used in step (a) to a first heat transmission medium by means of at least one exchanger, thereby heating the first heat transmission medium to a maximal temperature in the range between 8° and 150° C.

In preferred embodiments of the present invention the metal oxides or metalloid oxides are selected from the oxides of aluminum (Al), titanium (Ti), zirconium (Zr), yttrium (Y), lithium (Li), magnesium (Mg), lanthanum (La), cerium (Ce), iron (Fe), zinc (Zn), and silicon (Si).

In particularly preferred embodiments of the present invention the metal oxides or metalloid oxides are selected from the oxides of aluminum (Al), titanium (Ti), and silicon (Si).

According to the present invention the metal precursor or metalloid precursor is a compound containing one or more metals or metalloids, which compound undergoes chemical transformation, when exposed to a flame formed by burning a gas mixture comprising oxygen and hydrogen, into a mixture of one or more solid (at 25° C. and atmospheric pressure) oxides of a metal or metalloid and compounds that are gaseous or volatile at 25° C. and atmospheric pressure.

In preferred embodiments of the present invention the metal precursor or metalloid precursor is selected from aluminum chloride, aluminum oxychloride, titanium tetrachloride, titanium trichloride, titanium oxychloride, tetraalkoxytitanate, tetraalkoxysilicate, cyclic or acyclic siloxane, silicon tetrachloride, trichlorosilane, methyltrichlorosilane, dichlorosilane, monochlorosilane or mixtures thereof.

Forming a flame by burning a gas mixture comprising oxygen and hydrogen and introducing a metal precursor and/or a metalloid precursor therein, according to the present invention can be achieved by any means known to people of skill in the art. Comprehensive descriptions of such pyrogenic processes particularly suitable for the purpose of the present invention have been described in the art, cf. e.g. Ullmann's Encyclopedia of Industrial Chemistry (1982) Volume 21, page 464.

According to the present invention at least a part of the hydrogen used for forming the flame is obtained from electrolysis of water or an aqueous solution, using electrical energy, at least a part of which has been obtained from a renewable energy source. A wide spectrum of processes for the production of hydrogen from electrolysis of water or aqueous solutions are available in the art, all of which can be used in the context of the present invention.

According to the present invention, further, at least a part of the thermal energy of the flame used in step (a) is transferred a first heat transmission medium by means of at least one exchanger, thereby heating the first heat transmission medium to a maximal temperature in the range between 80 and 150° C. The limited temperature range is advantageous over known processes using higher temperatures. A lower heat exchanger temperature (80-150° C.) leads to better stability of the burner materials in the flame process, results in better product properties and leads to less heat loss due to less heat radiation (depending on temperature to fourth power) in the process.

Typically, transferring thermal energy of the flame to the first heat transmission medium is achieved with heat exchangers arranged in suitable proximity to the flame.

Heat exchangers are well-known and widely used in a number of environments to recover thermal energy from fluids. Heat exchangers work by transferring heat from one fluid to another via a solid wall, which separates the two fluids. A number of designs of heat exchangers exist. The typical heat exchanger designs include double-pipe heat exchangers, shell-and-tube heat exchangers, plate heat exchangers, and condensers and boilers heat exchangers. There are three primary classifications of heat exchangers according to their flow arrangement. In parallel-flow heat exchangers, the two fluids enter the exchanger at the same end, and travel in parallel to one another to the other side. In counter-flow heat exchangers the fluids enter the exchanger from opposite ends. The counter current design is the most efficient, in that it can transfer the most heat from the heat (transfer) medium per unit mass due to the fact that the average temperature difference along any unit length is higher. In a cross-flow heat exchanger, the fluids travel roughly perpendicular to one another through the exchanger. The corresponding equipment is commercially available and widely used by people of skill in the field of chemical process technology.

A number of heat transmission mediums that are suitable as the first heat transmission medium are known to people of skill in the art in this field. In addition to a sufficiently low freezing point, a sufficiently high boiling point, and sufficiently high chemical stability, typically, such heat transmission mediums, further, exhibit some or all of the following properties: high specific heat capacity, high heat-transfer coefficient, high thermal conductivity, low viscosity, non-flammability, non-explosiveness, low-toxicity, non-corrosiveness with respect to the process equipment used. In preferred embodiments of the present invention the first heat transmission medium is water. In preferred embodiments of the present invention the renewable energy source is selected from the group consisting of solar energy, wind energy, geothermal energy, hydropower from flowing water, tidal energy, energy obtained from burning of biomass, waste or biofuel, and combinations of these energy sources.

The maximal temperature range of 80 to 150° C. of the first heat transmission medium is suitable for using it e.g. for heating of houses, but is usually too low for further converting it to any particularly useful in the industrial setting purpose, e.g. generate electricity.

Therefore, in a particularly preferred embodiment of the invention, the heat of the first heat transmission medium is further transferred to a second heat transmission medium and electrical energy is generated by passing this second heat transmission medium heated to a temperature above its boiling point under standard conditions through an expansion device. According to this preferred embodiment the process of the present invention comprises the following steps:
(a) introducing a metal precursor and/or a metalloid precursor into a flame,
   wherein the flame used in step (a) is formed by burning a gas mixture comprising oxygen and hydrogen,
   wherein at least a part of the hydrogen has been obtained from electrolysis of water or an aqueous solution, using electrical energy, at least a part of which has been obtained from a renewable energy source,
(b) transferring at least a part of the thermal energy of the flame used in step (a) to a first heat transmission medium, thereby heating the first heat transmission medium to a maximal temperature in the range between 8° and 150° C.,
(c) transferring at least a part of the thermal energy of the first heat transmission medium, exhibiting a maximal temperature in the range between 80 and 150° C., to a second heat transmission medium by means of at least one exchanger, thereby heating the second heat transmission medium to a temperature above its boiling point under standard conditions and thus generating an overheated second heat transmission medium with a pressure of at least 1.1 bar abs,
(d) passing at least a part of the overheated second heat transmission medium through an steam turbine, thus generating electrical energy.

According to this preferred embodiment, thus, at least a part of the thermal energy of the first heat transmission medium, exhibiting a maximal temperature in the range between 8° and 150° C., is transferred to a second heat transmission medium, thereby heating the second heat transmission medium to a temperature above its boiling point under standard conditions and thus generating an overheated second heat transmission medium with a pressure of at least 1.1 bar abs. Typically, transferring thermal energy from the first heat transmission medium to the second heat transmission medium is achieved with heat exchangers. A general description for suited heat exchangers is mentioned above for step (b). Again, the corresponding equipment is commercially available and widely used by people of skill in the field of chemical process technology.

In the context of the present invention standard conditions are defined as temperature of 273,15 K=0° C. and pressure of 100000 Pa=1,000 bar.

According to the present invention the overheated second heat transmission medium exhibits a pressure of at least 1.1 bar abs, wherein the pressure is defined in absolute terms, i.e. compared to a perfect vacuum.

A number of heat transmission mediums that are suitable as the second heat transmission medium are known to people of skill in the art in this field. In addition to a sufficiently low freezing point, a sufficiently high boiling point, and sufficiently high chemical stability, typically, such heat transmission mediums, further, exhibit some or all of the following properties: high specific heat capacity, high heat-transfer coefficient, high thermal conductivity, low viscosity, non-flammability, non-explosiveness, low-toxicity, non-corrosiveness with respect to the process equipment used.

In preferred embodiments of the present invention the second heat transmission medium is selected from hydrocarbons with up to 6 carbon atoms, such as propane, cyclopropane, butane, isobutane, pentane, cyclopentane, hexane, as well as halogenated hydrocarbons, and mixtures thereof.

At least a part of the overheated second heat transmission medium is passed through an steam turbine, generating electrical energy thereby. The term “steam turbine” refers in the context of the present invention to any device, in which a pressured to >1 bar abs gas can be expanded, i.e. reduced in pressure to produce work that in turn can be used to drive a compressor or generator. Equipment for this process step is commercially available and widely used by people of skill in this field.

In preferred embodiments of the present invention the steam turbine is an expansion turbine, also known as turboexpander.

In preferred embodiments of the present invention at least a part of the first heat transmission medium is used for one or more of the following:
heating the metal precursor and/or the metalloid precursor before using them in step (a) of the process,
heating at least one gas before using it in step (a) of the process.

Using the first heat transmission medium for heating the metal/metalloid precursor or for heating one or more of the gases before introducing them into the flame allows energy to be saved and emissions to be reduced in the overall process. Heat transfer from the first heat transmission medium to metal/metalloid precursors or one or more of the gases can be achieved with conventional process equipment, e.g. heat exchangers, commercially available and well known in the art.

In preferred embodiments of the present invention at least a part of the electrical energy generated by the process is used for one or more of the following:
obtaining hydrogen from electrolysis of water or an aqueous solution and using at least a part of this hydrogen in step (a) of the process,
heating the metal precursor and/or the metalloid precursor before using them in step (a) of the process,
heating at least one gas before using it in step (a) of the process,
powering at least one pump used in the process.

In preferred embodiments of the present invention
the metal oxide or the metalloid oxide is selected from the oxides of aluminum (Al), titanium (Ti), and silicon (Si), and
at least a part of the first heat transmission medium is used for one or more of the following:
   heating the metal precursor and/or the metalloid precursor before using them in step (a) of the process,
   heating at least one gas before using it in step (a) of the process.

In further preferred embodiments of the present invention
the metal oxide and/or metalloid oxide is selected from the oxides of aluminum (Al), titanium (Ti), and silicon (Si), and
at least a part of the electrical energy generated by the process is used for one of the following:
   obtaining hydrogen from electrolysis of water or an aqueous solution and using at least a part of this hydrogen in step (a) of the process,
   heating metal precursors or metalloid precursors before using them in step (a) of the process,
   heating at least one gas before using it in step (a) of the process,
   powering at least one pump used in the process.

In preferred embodiments of the present invention oxygen is obtained from electrolysis of water or an aqueous solution, using electrical energy, at least a part of which has been obtained from a renewable energy source, and wherein at least a part of this oxygen is used in step (a) of the process.

1. A process for manufacturing a metal oxide or a metalloid oxide, comprising the following:
(a) introducing a metal precursor and/or a metalloid precursor into a flame,
wherein the flame used in (a) is formed by burning a gas mixture comprising oxygen and hydrogen,
wherein at least a part of the hydrogen has been obtained from electrolysis of water or an aqueous solution, using electrical energy, at least a part of which has been obtained from a renewable energy source,
(b) transferring at least a part of the thermal energy of the flame used in (a) to a first heat transmission medium by at least one exchanger, thereby heating the first heat transmission medium to a maximal temperature in a range between 8° and 150° C.

2. The process according to claim 1, further comprising the following:
(c) transferring at least a part of the thermal energy of the first heat transmission medium, exhibiting a maximal temperature in the range between 8° and 150° C., to a second heat transmission medium by at least one exchanger, thereby heating the second heat transmission medium to a temperature above its boiling point under a standard condition and thus generating an overheated second heat transmission medium with a pressure of at least 1.1 bar abs,
(d) passing at least a part of the overheated second heat transmission medium through a steam turbine, thus generating electrical energy.

3. The process according to claim 1, wherein the renewable energy source is selected from the group consisting of solar energy, wind energy, geothermal energy, hydropower from flowing water, tidal energy, energy obtained from burning of biomass, waste or biofuel, and combinations of these energy sources.

4. The process according to claim 1, wherein the metal oxide or the metalloid oxide is selected from an oxide of aluminum, titanium, zirconium, yttrium, lithium, magnesium, lanthanum, cerium, iron, zinc, and silicon.

5. The process according to claim 1, wherein the metal oxide or the metalloid oxide is selected from an oxide of aluminum, titanium, and silicon.

6. The process according to claim 1, wherein the metal precursor or the metalloid precursor is selected from the group consisting of aluminum chloride, aluminum oxychloride, titanium tetrachloride, titanium trichloride, titanium oxychloride, tetraalkoxytitanate, tetraalkoxysilicate, cyclic or acyclic siloxane, silicon tetrachloride, trichlorosilane, methyltrichlorosilane, dichlorosilane, and monochlorosilane or a mixture thereof.

7. The process according to claim 1, wherein the first heat transmission medium is water.

8. The process according to claim 2, wherein the second heat transmission medium is selected from the group consisting of a hydrocarbon with up to 6 carbon atoms and a halogenated hydrocarbon or a mixture thereof.

9. The process according to claim 2, wherein the expansion device is an expansion turbine.

10. The process according to claim 1, wherein at least a part of the first heat transmission medium is used for one or more of the following:
heating the metal precursor and/or the metalloid precursor before using them in (a) of the process,
heating at least one gas before using it in (a) of the process.

11. The process according to claim 2, wherein at least a part of the electrical energy generated by the process is used for one or more of the following:
obtaining hydrogen from electrolysis of water or an aqueous solution and using at least a part of the hydrogen in (a) of the process,
heating the metal precursor and/or the metalloid precursor before using them in (a) of the process,
heating at least one gas before using it in (a) of the process,
powering at least one pump used in the process.

12. The process according to claim 1, wherein
the metal oxide or the metalloid oxide is selected from an oxide of aluminum, titanium, and silicon, and wherein
at least a part of the first heat transmission medium is used for one or more of the following:
heating the metal precursor and/or the metalloid precursor before using them in (a) of the process,
heating at least one gas before using it in (a) of the process.

13. The process according to claim 2, wherein
the metal oxide and/or the metalloid oxide is selected from an oxide of aluminum, titanium, and silicon, and wherein
at least a part of the electrical energy generated by the process is used for one of the following:
obtaining hydrogen from electrolysis of water or an aqueous solution and using at least a part of the hydrogen in (a) of the process,
heating the metal precursor or the metalloid precursor before using them in (a) of the process,
heating at least one gas before using it in (a) of the process,
powering at least one pump used in the process.

14. The process according to claim 1, wherein oxygen is obtained from electrolysis of water or an aqueous solution, using electrical energy, at least a part of which has been obtained from a renewable energy source, and wherein at least a part of the oxygen is used in (a) of the process.
